(19) United States
(12) Patent Application Publication
(10) Pub. No.: US 2026/0127420 A1
(43) Pub. Date: May 7, 2026

(54) METHOD AND APPARATUS WITH NEURAL NETWORK MODEL QUANTIZATION

(71) Applicant: Samsung Electronics Co., Ltd., Suwon-si (KR)

(72) Inventors: Minjeong CHOI, Suwon-si (KR); Jaehoon YU, Suwon-si (KR); Won-Jo LEE, Suwon-si (KR)

(73) Assignee: Samsung Electronics Co., Ltd., Suwon-si (KR)

(21) Appl. No.: 19/195,861

(22) Filed: May 1, 2025

(30) Foreign Application Priority Data
Nov. 7, 2024 (KR) 10-2024-0157208

(51) Int. Cl. G06N 3/0495

(52) U.S. Cl. CPC G06N 3/0495

(57) ABSTRACT

A processor-implemented method including obtaining first data in an integer (INT) form by performing a first quantization on input activation data, applying a block-wise orthogonal matrix to the first data to obtain second data, and performing a second quantization on the second data to obtain third data, the block-wise orthogonal matrix including a plurality of orthogonal matrices arranged diagonally.

### CROSS-REFERENCE TO RELATED APPLICATIONS

This application claims the benefit under 35 USC § 119 (a) of Korean Patent Application No. 10-2024-0157208, filed on Nov. 7, 2024, in the Korean Intellectual Property Office, the entire disclosure of which is incorporated herein by reference for all purposes.

### BACKGROUND

### 1. Field

The following description relates to a method and apparatus with neural network model quantization.

### 2. Description of Related Art

A large language model (LLM), which has recently been developed as one of the deep learning models, is a model for generating answers corresponding to text-type queries. Recently, LLM's have become generally large models including billions or even more than 10 billion parameters. However, a capacity of dynamic random-access memory (DRAM) hardware to operate that kind of an LLM is relatively limited. To overcome such hardware constraints, quantization technology to reduce the size of the LLM and to convert the LLM into a model suitable for actual services is typically used.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including obtaining first data in an integer (INT) form by performing a first quantization on input activation data, applying a block-wise orthogonal matrix to the first data to obtain second data, and performing a second quantization on the second data to obtain third data, the block-wise orthogonal matrix including a plurality of orthogonal matrices arranged diagonally.

The method may include generating the block-wise orthogonal matrix based on information related to one of the input activation data or the first data.

The generating of the block-wise orthogonal matrix may include deriving a dimension in which an outlier occurs in the input activation data or the first data and generating the block-wise orthogonal matrix in response to the derived dimension.

The deriving of the dimension in which the outlier occurs may be performed offline in advance based on data previously constructed in relation to a neural network model.

The generating of the block-wise orthogonal matrix may include recursively extending or reducing a base orthogonal matrix to generate at least one orthogonal matrix candidate based on the information related to the one of the input activation data or the first data and repeatedly arranging the at least one orthogonal matrix candidate diagonally.

The generating of the block-wise orthogonal matrix may include loading a block-wise orthogonal matrix that is previously generated, from a lookup table, based on the information related to the one of the input activation data or the first data.

The applying the block-wise orthogonal matrix may include applying the block-wise orthogonal matrix and a scaling factor of the block-wise orthogonal matrix to the first data to obtain the second data.

The applying the block-wise orthogonal matrix may include, in response to the scaling factor of the block-wise orthogonal matrix not being an INT, obtaining transferred a scaling factor, the transferred scaling factor being received by the block-wise orthogonal matrix in response to a portion of the scaling factor of a transpose matrix of the block-wise orthogonal matrix and calculating the transferred scaling factor by using a shifter to obtain the second data.

Each of the plurality of orthogonal matrices may include at least one element of {−1, 0, 1}.

The method may include obtaining a parameter matrix in which a transpose matrix of the block-wise orthogonal matrix and a weight of a neural network model are pre-calculated and applying the parameter matrix to the third data to output fourth data.

Respective sizes of the plurality of orthogonal matrices may be a same size.

Two or more respective sizes of the plurality of orthogonal matrices may be different sizes.

In a general aspect, here is provided a non-transitory computer-readable storage medium storing instructions that, when executed by a processor, cause the processor to perform the method.

In a general aspect, here is provided an electronic apparatus included processors configured to execute instructions and a memory storing the instructions, and an execution of the instructions configures the processors to perform a first quantization on input activation data to obtain first data in a form of an integer (INT), apply a block-wise orthogonal matrix to the first data to obtain second data, and perform a second quantization on the second data to obtain third data, the block-wise orthogonal matrix including a plurality of orthogonal matrices arranged diagonally.

The processors may be further configured to generate the block-wise orthogonal matrix based on information related to one of the input activation data or the first data and each of the plurality of orthogonal matrices includes at least one element of {−1, 0, 1}.

The applying the block-wise orthogonal matrix may include applying the block-wise orthogonal matrix and a scaling factor of the block-wise orthogonal matrix to the first data to obtain the second data.

The applying the block-wise orthogonal matrix may include, in response to the scaling factor of the block-wise orthogonal matrix not being an INT, obtaining a transferred scaling factor, the transferred scaling factor being received by the block-wise orthogonal matrix in response to a portion of the scaling factor of a transpose matrix of the block-wise orthogonal matrix and calculating the transferred scaling factor by using a shifter to obtain the second data.

The processors may be further configured to obtain a parameter matrix in which a transpose matrix of the block-wise orthogonal matrix and a weight of a neural network model are pre-calculated and apply the parameter matrix to the third data to obtain fourth data.

In a general aspect, here is provided an electronic device including shifter circuitry including at least one shifter logic and integer (INT) operation circuitry including at least one INT operation logic, the shifter circuitry being configured to generate first data in a form of an INT by performing a first quantization on input activation data, generate second data by applying a block-wise orthogonal matrix to the first data, the shifter circuitry being configured to obtain third data by performing a second quantization on the second data, and the block-wise orthogonal matrix includes a plurality of orthogonal matrices arranged diagonally.

The device may include matrix generation circuitry including generation logic of at least one block-wise orthogonal matrix, the generation logic may be configured to generate the block-wise orthogonal matrix based on information related to the input activation data or the first data, and the shifter circuitry may be configured to obtain the second data by performing computation by applying the block-wise orthogonal matrix and a scaling factor of the block-wise orthogonal matrix to the first data.

Other features and aspects will be apparent from the following detailed description, the drawings, and the claims.

### BRIEF DESCRIPTION OF THE DRAWINGS

FIG. 1 illustrates an example quantization method of a neural network model according to one or more embodiments.

FIG. 2 illustrates an example method of generating a block-wise orthogonal matrix according to one or more embodiments.

FIG. 3 illustrates an example method of calculating a scaling factor of a block-wise orthogonal matrix according to one or more embodiments.

FIG. 4 illustrates an example illustration of computational complexity of a block-wise orthogonal matrix according to one or more embodiments.

FIG. 5 illustrates an example quantization method of a neural network model according to one or more embodiments.

FIG. 6 illustrates an example quantization method of a neural network model according to one or more embodiments.

FIG. 7 illustrates an example electronic apparatus with quantization according to one or more embodiments.

FIG. 8 illustrates an example quantization apparatus according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms.

Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

As used in connection with various example embodiments of the disclosure, any use of the terms “module” or “unit” means hardware and/or processing hardware configured to implement processor or computer executable instructions (e.g., as code segment(s), program(s), and/or firmware) to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such executable instructions may include components such as program components, object-oriented code or program components, class components, and may include processor task components, processes, functions, attributes, procedures, subroutines, segments of the code or program. Executable instructions may further include programs, drivers, firmware, microcode, circuits, data, database, data structures, tables, arrays, and variables. In another non-limiting example, such executable instructions may be executed by one or more central processing units (CPUs) of an electronic device or secure multimedia card.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

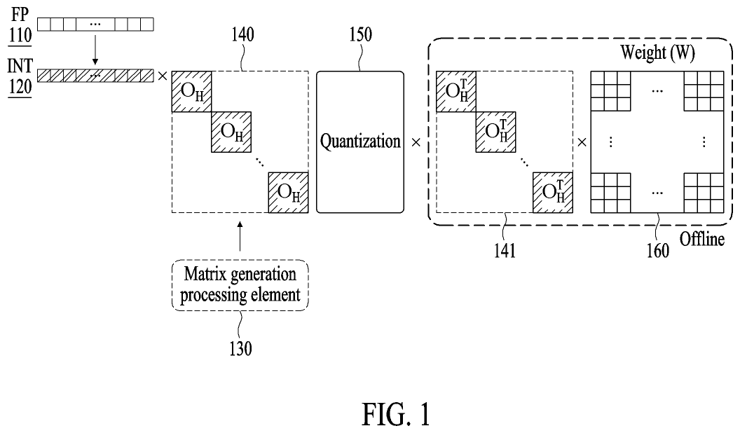

FIG. 1 illustrates an example quantization method of a neural network model according to one or more embodiments.

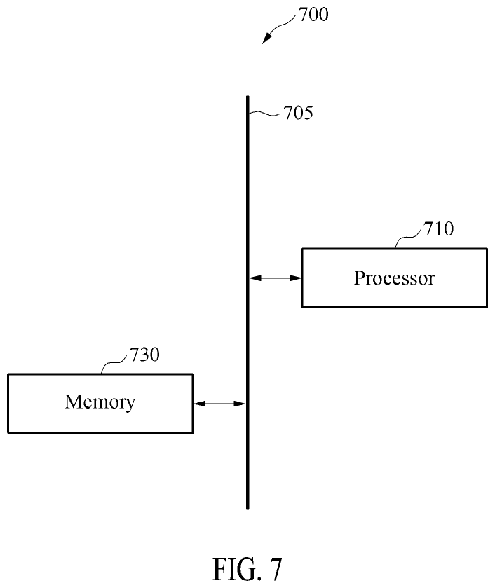

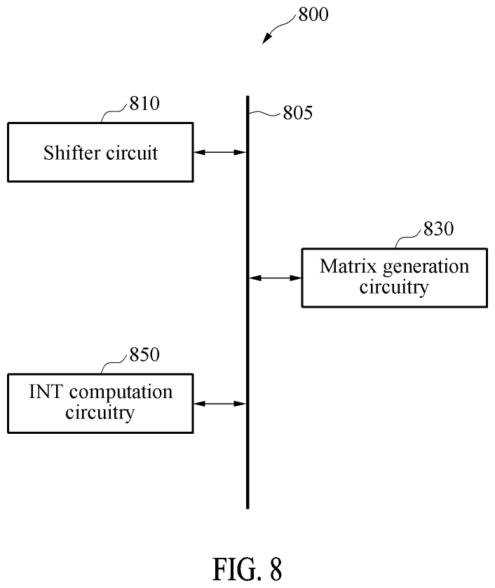

In an example, a quantization method may be driven by a quantization apparatus (e.g., electronic apparatus 700 of FIG. 7 and/or quantization apparatus 800 of FIG. 8) including a memory and one or more processors connected to the memory. For example, the quantization apparatus according to an example may be implemented by one or more processing elements communicating with each other. For example, while an element may be referred to as a processing element, it may include one or more processing elements including one or more processors. Depending on implementation methods of examples, the quantization apparatus may operate in the form of a server, an edge device, and in some cases, a server and an edge device communicating with each other.

Referring to FIG. 1, in a non-limiting example, a quantization apparatus (e.g., quantization apparatus 800 of FIG. 8) may include a matrix generation processing element 130. The matrix generation processing element 130 may obtain first data 120 in the form of an integer (INT) by performing a first quantization on input activation data 110. The quantization apparatus may reduce computational complexity of an overall quantization process by converting the input activation data 110 in the form of a floating point (FP) into data in the form of an INT.

For example, the first quantization according may be performed using a quantization magnification. The quantization magnification may refer to a value used when mapping a predetermined range of data in the form of an FP to data in the form of an INT that is to be quantized. The quantization apparatus may use a quantization magnification in the form of exponentiation of 2 in the first quantization.

In an example, the first quantization of the quantization apparatus may be performed by a method of determining the quantization magnification based on the maximum value of the input activation data 110. When this method is used, the quantization apparatus may determine the quantization magnification in the form of exponentiation of 2 based on the maximum value of the input activation data 110 expressed in the form of an FP, thereby performing quantization by using only an INT operation and a shift operation instead of a high-cost FP operation. To this end, the quantization apparatus may reduce area and power during hardware design by using only an INT operator and not an FP operator. In addition, the quantization apparatus may reduce operation time (latency) and may efficiently use hardware resources by using the quantization method that considers an operation of the hardware.

Quantization may refer to technology of converting data into a lower number of bits by dividing a range between the maximum value and the minimum value of given data into several intervals. In a neural network model (or a deep learning model), quantization may generally refer to technology of converting a weight and activation data into a lower number of bits.

Activation data of the neural network model (or the deep learning model) may generally include more outliers than weights. When data to be quantized includes an outlier with a value that is very large compared to an average of the data, a quantization error may occur. The activation data of the neural network model (or the deep learning model) may have a greater impact on the quantization error than weights. Depending on how this outlier is processed, performance of the neural network model (or the deep learning model) after the quantization may vary.

In an example, the quantization apparatus may obtain second data by applying a block-wise orthogonal matrix 140 to the first data 120.

In an example, the quantization apparatus may perform computations on the input activation data 110 converted into the form of an INT with the block-wise orthogonal matrix 140 subsequently and may distribute outliers included in the input activation data 110 to different dimensions (or channels). By distributing the outliers, the quantization apparatus may expect high accuracy while not lowering performance of the overall neural network model.

The block-wise orthogonal matrix 140 may include a plurality of orthogonal matrices and thus may be generated so that not all elements of an orthogonal matrix corresponding to the size of an entire dimension of the first data 120 necessarily have values. For example, as the plurality of orthogonal matrices are allocated in response to some dimensions into which the entire dimension of the first data 120 is divided, characteristics according to the dimension (or a channel) in the first data 120 may be considered and memory space and computational complexity may be reduced.

In an example, a block-wise orthogonal matrix 140 may be generated by the matrix generation processing element 130. The matrix generation processing element 130 may generate various types of orthogonal matrices (e.g., a rotation matrix, a Hadamard matrix, or a matrix obtained by training in a stochastic gradient descent (SGD) method using Cayley transform). The matrix generation processing element 130, in an example, may be implemented through a trainable model.

The block-wise orthogonal matrix 140 may include a plurality of orthogonal matrices O_{H} arranged diagonally. Referring to the block-wise orthogonal matrix 140, the plurality of orthogonal matrices O_{H} may be independently arranged along a main diagonal of the block-wise orthogonal matrix 140 within the block-wise orthogonal matrix 140. For example, each of the orthogonal matrices O_{H} may follow the size of exponentiation of 2.

In an example, each of the plurality of orthogonal matrices O_{H} may include an INT element. For example, each of the plurality of orthogonal matrices O_{H} may be a matrix including at least one element of {−1, 0, 1}. By using an orthogonal matrix including an element in the form of an INT, the quantization apparatus may perform a relatively low-cost INT operation instead of a high-cost FP operation.

In an example, the matrix generation processing element 130 may generate the block-wise orthogonal matrix 140 based on information related to the input activation data 110 or the first data 120.

In order to apply the block-wise orthogonal matrix 140 to the first data 120, a dimension of the block-wise orthogonal matrix 140 may be the same as the dimension of the first data 120. The quantization apparatus may generate the block-wise orthogonal matrix 140 based on dimension information of the first data 120 from among information related to the first data 120. In addition, during a process of converting input data into a lower precision value by quantization, the form or array structure of the input data may not be changed. The quantization apparatus may utilize not only the dimension information of the first data 120 (a quantized value of the input activation data 110) but also dimension information of the input activation data 110, in generating the block-wise orthogonal matrix 140.

The matrix generation processing element 130 may generate the block-wise orthogonal matrix 140 so that the size (e.g., the sum of the sizes of dimensions of the plurality of orthogonal matrices) of the dimension of the block-wise orthogonal matrix 140, which is generated by arranging the plurality of orthogonal matrices diagonally, corresponds to the size of the dimension of the first data 120. Since the block-wise orthogonal matrix 140 includes the plurality of orthogonal matrices, the matrix generation processing element 130 may generate a matrix so that not all elements of the orthogonal matrix corresponding to the size of the entire dimension of the first data 120 necessarily have values. For example, the block-wise orthogonal matrix 140 may be a matrix in which a value is only assigned to a portion corresponding to the plurality of orthogonal matrices. Therefore, as the matrix generation processing element 130 generates an orthogonal matrix smaller than the size of the dimension of the first data 120, the matrix generation processing element 130 may reduce the amount of data that needs to be stored in memory, thereby reducing storage space and computation.

In an example, the quantization apparatus may obtain third data by performing a second quantization 150 on the second data. The second data may refer to the input activation data 110 in the form of an INT to which the block-wise orthogonal matrix 140 is applied. The quantization apparatus may quantize the second data (e.g., the second quantization 150) in the form of a target number system. The third data may be expressed in various forms such as an INT, a fixed point, or an FP, depending on the target number system.

In an example, the second quantization 150 may use the same quantization method used in the first quantization. For example, the quantization magnification may be set to the form of exponentiation of 2. The second quantization 150 may perform quantization using only an INT operation and a shift operation, like the first quantization, thereby reducing hardware cost.

In order to perform computation of the neural network model (or the deep learning model) based on the third data, a transpose matrix 141 of the block-wise orthogonal matrix 140 and a weight 160 of the neural network model may be calculated offline in advance. For example, a parameter matrix may be generated by calculating the transpose matrix 141 and the weight 160 to perform merging and quantization in advance.

The orthogonal matrix may have characteristics that a transpose matrix is the same as an inverse matrix. For example, since A^{T}=A⁻¹ for an orthogonal matrix A, the product of the orthogonal matrix A and a transpose matrix A^{T} of the orthogonal matrix A may become a unit matrix I. The transpose matrix 141 of the block-wise orthogonal matrix 140 may refer to a matrix including a transpose matrix O_{H}^{T} of each of the plurality of orthogonal matrices O_{H} included in the block-wise orthogonal matrix 140.

A separate electronic device that may be distinguished by being connected to the quantization apparatus or an electronic device including the quantization apparatus (hereinafter, “a computing device”) may obtain the parameter matrix from the memory. Since the computing device may use pre-calculated values such as the parameter matrix in a processing process, performance of the neural network model (or the deep learning model) may be improved and computing time may be shortened.

The computing device may output fourth data by applying the parameter matrix to the third data. The third data may refer to a quantized value of the input activation data 110 (e.g., the second data) in the form of an INT to which the block-wise orthogonal matrix 140 is applied. The computing device may output the fourth data including the result of multiplying the block-wise orthogonal matrix 140 by the transpose matrix 141 by applying the parameter matrix calculated based on the transpose matrix 141 to the third data. As the block-wise orthogonal matrix 140 applied to the third data is multiplied by the transpose matrix 141, the distributed dimension (e.g., the dimension generated by using the block-wise orthogonal matrix 140) may revert back to the original dimension (e.g., the dimension of the input activation data 110).

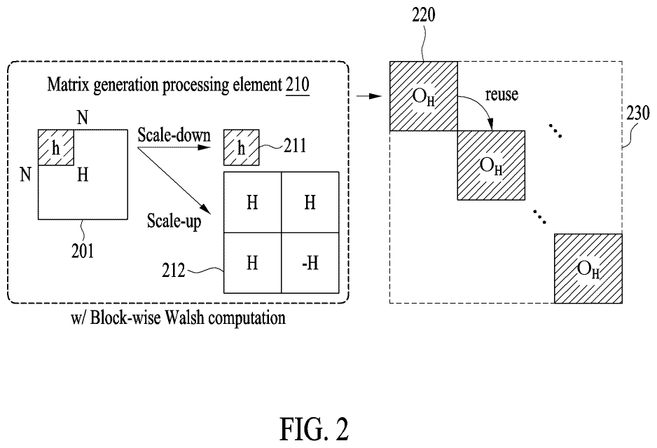

FIG. 2 illustrates an example method of generating a block-wise orthogonal matrix according to one or more embodiments.

The description provided with reference to FIG. 1 may apply to FIG. 2, and any repeated description related thereto may be omitted.

Referring to FIG. 2, in a non-limiting example, the generating a block-wise orthogonal matrix may be performed by a matrix generation processing element 210 (e.g., electronic apparatus 700 of FIG. 7). The matrix generation processing element 210 may calculate an orthogonal matrix O_{H}. The orthogonal matrix O_{H} may include a Hadamard matrix including elements of {−1, 1}. The Hadamard matrix may refer to a square matrix in which all rows and columns are orthogonal to each other. When the block-wise orthogonal matrix 140 is configured with the Hadamard matrix, a block-wise orthogonal matrix 230 may refer to a matrix having a butterfly structure (hereinafter, referred to as a “block-wise Hadamard matrix”) in which a plurality of Hadamard matrices is diagonally arranged. The matrix generation processing element 210 according to an example may refer to a Hadamard matrix generation processing element.

In an example, the matrix generation processing element 210 may generate, based on the information related to the input activation data 110 or the first data 120, at least one orthogonal matrix candidate 220 by recursively extending or reducing a base orthogonal matrix 201.

The base orthogonal matrix 201 may be an initial matrix having orthogonality and may refer to a matrix that is the starting point for generating an orthogonal matrix having a specific dimension size. The base orthogonal matrix 201 may be set based on the information related to the input activation data 110, hardware resource information, etc. The base orthogonal matrix 201 may be used to generate the orthogonal matrix candidates 220 of various sizes through a recursive extension or a reduction process.

For example, the Hadamard matrix may generate Hadamard matrices of various sizes through an extension or a reduction process using a recursive formula as Equation 1. The Hadamard matrix may be generated recursively, as shown in Equation 1.

$${H}_{2 n} = [ \begin{matrix}{H}_{n} & {H}_{n} \\ {H}_{n} & - {H}_{n}\end{matrix} ] \qquad Equation 1$$

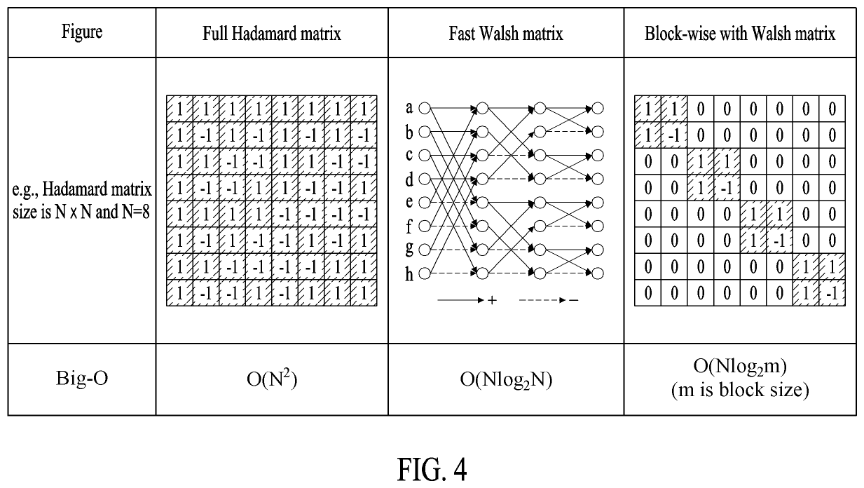

For example, the base orthogonal matrix 201 (H) may refer to Hₙ. The base orthogonal matrix 201 may be extended to generate a large orthogonal matrix candidate 212 of H₂ₙ. In addition, the matrix generation processing element 210 may extend or reduce the base orthogonal matrix 201 by using block-wise Walsh computation. The block-wise Walsh computation is described in greater detail below with reference to FIG. 4.

For example, when a dimension of the base orthogonal matrix 201 in the form of the Hadamard matrix is 2 to the power of N, the matrix generation processing element 210 may freely generate a Hadamard matrix having a dimension of exponentiation less than or greater than 2 to N. Particularly, if a dimension N of the base orthogonal matrix 201 is 256 (2⁸), the matrix generation processing element 210 may generate the orthogonal matrix candidate 220 of 128 (2⁷) or 512 (2⁹) dimensions.

The matrix generation processing element 210 may generate the block-wise orthogonal matrix 230 by repeatedly arranging at least one orthogonal matrix candidate 220 diagonally. Since the matrix generation processing element 210 may reuse at least one orthogonal matrix candidate 220 that has been generated once, the amount of computation may be effectively reduced.

The matrix generation processing element 210 may load a block-wise orthogonal matrix previously generated from a lookup table, based on the information related to the input activation data 110 or the first data 120. The matrix generation processing element 210 may load, from the lookup table, a block-wise orthogonal matrix having a dimension size corresponding to dimension information of the input activation data 110 or the first data 120. In addition, the matrix generation processing element 210 may load, from the lookup table, the block-wise orthogonal matrix having a dimension size corresponding to dimension information of the input activation data 110 or the first data 120 by additionally considering hardware resource information. The block-wise orthogonal matrix stored in the lookup table may be generated and stored in advance.

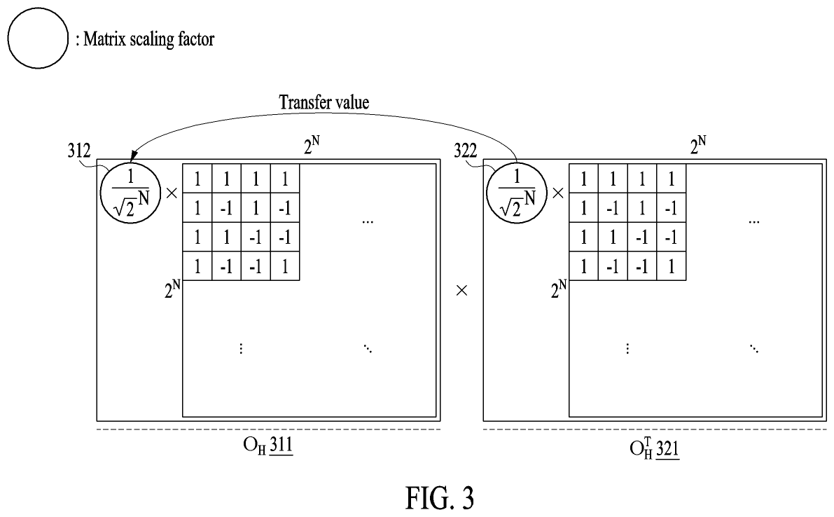

FIG. 3 illustrates an example method of calculating a scaling factor of a block-wise orthogonal matrix according to one or more embodiments.

The description provided with reference to FIGS. 1 and 2 may apply to FIG. 3, and any repeated description related thereto may be omitted.

Referring to FIG. 3, in a non-limiting example, a plurality of orthogonal matrices is illustrated as Hadamard matrices including {−1, 1}, but the example may also include a block-wise orthogonal matrix including {−1, 0, 1}.

The quantization apparatus may obtain the second data by performing computations by applying the block-wise orthogonal matrix and the scaling factor 312 of the block-wise orthogonal matrix to first data.

The quantization apparatus (e.g., quantization apparatus 800 of FIG. 8) may reduce the overall amount of computation by calculating the block-wise orthogonal matrix instead of an orthogonal matrix corresponding to the dimension size of the first data. By calculating the block-wise orthogonal matrix on the first data, the quantization apparatus may distribute outlier data included in the first data into different dimensions.

Since the first data is converted into INT form through a first quantization process, the quantization apparatus may perform application of the block-wise orthogonal matrix by using only INT operation hardware. In addition, the quantization apparatus may adopt a simple INT operator structure compared to an FP operator structure, thereby saving hardware cost.

The block-wise orthogonal matrix generated from a matrix generation processing element may include a scaling factor. The scaling factor according to an example may refer to a constant that is equally multiplied to each of at least one orthogonal matrix included in the block-wise orthogonal matrix. The quantization apparatus may extend or reduce each of at least one orthogonal matrix included in the block-wise orthogonal matrix in a predetermined ratio by applying the scaling factor to perform computation.

In an example, the size of the scaling factor may be determined according to the size of the block-wise orthogonal matrix. More particularly, when the size of the block-wise orthogonal matrix is A×A, the scaling factor may be expressed as 1/\sqrt{A}. For example, in the case of the block-wise orthogonal matrix including a plurality of Hadamard matrices, when the size of the block-wise orthogonal matrix is 2^{N}×2^{N}, the block-wise orthogonal matrix may have a scaling factor in the form of 2^{N/2}.

When the scaling factor 312 of the block-wise orthogonal matrix is not an INT, the quantization apparatus may obtain a scaling factor that is transferred to the block-wise orthogonal matrix in response to a portion of a scaling factor 322 of a transpose matrix of the block-wise orthogonal matrix. For example, when the scaling factor 312 of the block-wise orthogonal matrix has the scaling factor in the form of 2^{N/2}, and when N is odd, the block-wise orthogonal matrix may have a scaling factor in the form of an FP. Accordingly, the quantization apparatus may perform an FP operation rather than an INT operation. Accordingly, the scaling factor 322 of the transpose matrix of the block-wise orthogonal matrix may be completely or partly transferred to the scaling factor 312 of the block-wise orthogonal matrix to obtain a scaling factor of INT exponentiation of 2 (e.g., in the case of N being even).

The quantization apparatus may calculate a scaling factor transferred using a shifter to obtain the second data. Since the quantization apparatus transfers at least a portion of the scaling factor 322 of the transpose matrix of the block-wise orthogonal matrix, the quantization apparatus may perform computations using the scaling factor of INT exponentiation of 2, thereby allowing an INT operation and an operation using the shifter.

FIG. 4 illustrates an example illustration of computational complexity of a block-wise orthogonal matrix according to one or more embodiments.

The description provided with reference to FIGS. 1 to 3 may apply to FIG. 4, and any repeated description related thereto may be omitted.

According to an example, a quantization apparatus (e.g., quantization apparatus 800 of FIG. 8) may reduce the amount of computation by applying an orthogonal matrix to first data by using a fast Walsh-matrix method in units of orthogonal matrices (e.g., block units of block-wise orthogonal matrices) simultaneously with generation of an orthogonal matrix in a matrix generation processing element (e.g., electronic apparatus 700 of FIG. 7). The fast Walsh-matrix method may refer to a method of using a fast recursive computation that utilizes structural characteristics of a Hadamard transform using a divide and conquer technique.

Referring to FIG. 4, in a non-limiting example, computations performed by the quantization apparatus (e.g., quantization apparatus 800 of FIG. 8) is illustrated. In the computations, when the size of a matrix to be calculated is N×N, the amount of computation for each computation method is disclosed based on time complexity Big-O. The matrix generation processing element (e.g., matrix generation processing element 210) may have computational complexity of O(N²) when generating a Hadamard orthogonal matrix (a full Hadamard matrix) corresponding to the dimension size of the first data. On the contrary, when using the fast Walsh-matrix method, the matrix generation processing element may have computational complexity of O(Nlog₂N) when generating the same Hadamard matrix. When applying this to a block-wise orthogonal matrix, and when each of a plurality of orthogonal matrices included in the block-wise orthogonal matrix has a size of m, the matrix generation processing element may have computational complexity of O(Nlog₂m).

When the fast Walsh-matrix method is used, the matrix generation processing element may generate the same Hadamard matrix according to a computation rule without directly generating the Hadamard matrix of a target N-dimensional size. In addition, the matrix generation processing element may greatly reduce the amount of computation compared to an existing method by applying the generated Hadamard matrix to the block-wise orthogonal matrix of orthogonal matrix units.

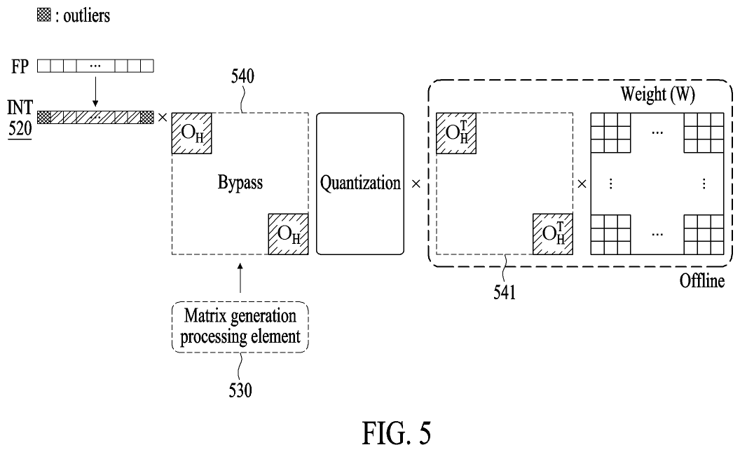

FIG. 5 illustrates an example quantization method of a neural network model according to one or more embodiments.

The description provided with reference to FIGS. 1 to 4 may apply to FIG. 5, and any repeated description related thereto may be omitted.

Referring to FIG. 5, in a non-limiting example, an example of a plurality of orthogonal matrices as a Hadamard matrix including {−1, 1} is illustrated, but the example may include a block-wise orthogonal matrix 540 including {−1, 0, 1}.

The quantization apparatus (e.g., quantization apparatus 800 of FIG. 8) may derive a dimension in which an outlier occurs in first data. In an example, a portion indicated by a grid pattern in first data 520 may represent a dimension including the outlier. In addition, in a process of converting input data into a value of lower precision through quantization, the form or array structure of the input data may not change, and therefore the dimension in which the outlier occurs may be derived based on not only the first data 520 but also input activation data.

At least one of the quantization apparatus, a separate electronic device distinguished from the quantization apparatus by being connected to the quantization apparatus, or an electronic device including the quantization apparatus (hereinafter, “a computing device”) (e.g., electronic apparatus 700 of FIG. 7) may derive the dimension in which the outlier occurs offline in advance based on data previously constructed in relation to a neural network model (a deep learning model). The computing device may detect the outlier by analyzing the input activation data or the first data 520 in advance, based on information already collected in relation to the neural network model (or the deep learning model).

In an example, a matrix generation processing element 530 may generate the block-wise orthogonal matrix 540 in response to the dimension in which the outlier is derived. The matrix generation processing element 530 may bypass computation by not generating an orthogonal matrix for a dimension in which the outlier does not occur, thereby reducing the amount of calculation and power consumption. In addition, when distribution of values of the input activation data or the first data 520 is even, and when the quantization apparatus multiplies the input activation data or the first data 520 by the block-wise orthogonal matrix 540, the matrix generation processing element 530 may eliminate a situation in which the distribution of values is concentrated on one side or the outlier is generated. Accordingly, the quantization apparatus may further improve performance (accuracy) of a model. The matrix generation processing element 530 may thereby generate an orthogonal matrix regardless of the size of the input activation data.

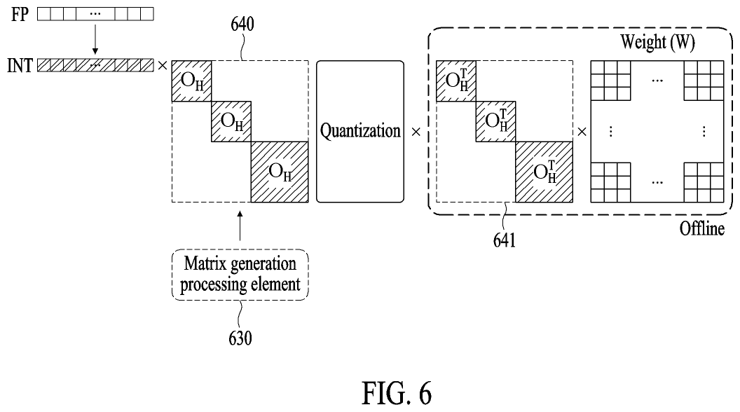

FIG. 6 illustrates an example quantization method of a neural network model according to one or more embodiments.

The description provided with reference to FIGS. 1 to 5 may apply to FIG. 6, and any repeated description related thereto may be omitted.

Referring to FIG. 6, in a non-limiting example, a matrix generation processing element 630 (e.g., electronic apparatus 700 of FIG. 7) may generate a block-wise orthogonal matrix 640 so that a plurality of orthogonal matrices has the same size. By repeatedly arranging and reusing at least one orthogonal matrix candidate that has been generated once, the matrix generation processing element 630 may generate the block-wise orthogonal matrix 640 so that the plurality of orthogonal matrices has the same size.

The matrix generation processing element 630 may generate the block-wise orthogonal matrix 640 so that at least some of the plurality of orthogonal matrices have different sizes. In an example, each of a plurality of orthogonal matrices O_{H} included in the block-wise orthogonal matrix 640 may be expressed as having different sizes.

In the case of most neural network models (or deep learning models), the size of the input activation data may be expressed as exponentiation of 2 or the sum of exponentiations of 2. For example, if the size of data is 11,008, the size of data may be expressed as 8192 (2¹³)+2048 (2¹¹)+512 (2⁹)+256 (2⁸). Each term (in the above example, 2¹³, 2¹¹, 2⁹, 2⁸) in a formula of the sum of exponentiations of 2 may be utilized as the size of a dimension of an orthogonal matrix. The matrix generation processing element 630 may generate orthogonal matrices of different sizes based on the size of the dimension of the orthogonal matrix corresponding to each term. Accordingly, the matrix generation processing element 630 may flexibly generate block-wise orthogonal matrices corresponding to various input data sizes.

FIG. 7 illustrates an example electronic apparatus with quantization according to one or more embodiments.

The description provided with reference to FIGS. 1 to 6 may apply to FIG. 7, and any repeated description related thereto may be omitted.

Referring to FIG. 7, in a non-limiting example, an electronic apparatus 700 may include a processor 710. The processor 710 may obtain first data in the form of an INT by performing a first quantization on input activation data. The processor 710 may be one or more processors. In an example, the processor 710 may include or make up the above mentioned processing elements, such as the matrix generation processing element 210. The processor 710 may obtain second data by applying a block-wise orthogonal matrix to the first data. The processor 710 may obtain third data by performing a second quantization 150 on the second data. The processor 710 may obtain a parameter matrix in which the transpose matrix of the block-wise orthogonal matrix and a weight of the neural network model are pre-calculated. The processor 710 may output fourth data by applying the parameter matrix to the third data. In addition, the processor 710 may include a matrix generation processing element and may cause the matrix generation processing element to generate the block-wise orthogonal matrix based on the input activation data or information related to the first data.

The memory 730 may include computer-readable instructions. The processor 710 may be configured to execute computer-readable instructions, such as those stored in the memory 730, and through execution of the computer-readable instructions, the processor 710 is configured to perform one or more, or any combination, of the operations and/or methods described herein. In addition, the memory 730 may store various types of data and programs. The memory 730 may include a volatile memory or a non-volatile memory. The memory 730 may store a variety of data by including a large mass storage medium, such as a hard disk.

The processor 710 may further execute programs, and/or may control the electronic apparatus 700 and/or quantization apparatus 800 of FIG. 8 as described in greater detail below. In addition, the processor 710 may perform at least one method described with reference to FIGS. 1 to 6 or an algorithm corresponding to the at least one method. The processor 710 may be a data processing device configured as hardware having a circuit having a physical structure to implement desired operations. For example, the desired operations may include code or instructions in a program. The processor 710 may be implemented as, for example, a CPU, a GPU, or an NPU. For example, a quantization apparatus 700 that is implemented as hardware may include, for example, a microprocessor, a CPU, a processor core, a multi-core processor, a multiprocessor, an ASIC, and an FPGA.

The electronic apparatus 700 may be implemented as various types of devices, for example, a personal computer (PC), a server device, a mobile device, and an embedded device and in specific examples, may correspond to, for example, a smartphone, a tablet device, an augmented reality (AR) device, an internet of things (IoT) device, and/or a medical device that perform voice recognition, image recognition, and image classification based on a neural network, but examples are not limited thereto. Furthermore, the electronic apparatus 700 may correspond to a dedicated hardware accelerator mounted on the above-described devices or may be a hardware accelerator such as an NPU, a tensor processing unit (TPU), a memory operator, and/or a neural engine, which are dedicated processing elements for driving a neural network, but examples are not limited thereto.

FIG. 8 illustrates an example quantization apparatus according to one or more embodiments.

The description provided with reference to FIGS. 1 to 7 may apply to FIG. 8, and any repeated description related thereto may be omitted.

Referring to FIG. 8, in a non-limiting example, a quantization apparatus 800 may include a shifter circuitry 810, a matrix generation circuitry 830, and an INT computation circuitry 850. When implemented with dedicated hardware including such circuitry, a quantization method may be performed only with an INT operation and a shifter operation, thereby reducing cost. In addition to the dedicated hardware, high efficiency may be expected when the quantization method is applied to and performed on commercial hardware such as GPUs and NPUs.

The shifter circuitry 810 may include at least one shifter logic. The shifter circuitry 810 may be configured to generate first data in the form of an INT by performing a first quantization on input activation data. The shifter circuitry 810 may obtain third data by performing the second quantization 150 on second data. The shifter circuitry 810 may obtain the second data by performing a computation by applying the block-wise orthogonal matrix and a scaling factor of the block-wise orthogonal matrix to the first data.

The matrix generation circuitry 830 may include generation logic for the block-wise orthogonal matrix. The matrix generation circuitry 830 may generate various types of orthogonal matrices (e.g., a rotation matrix, a Hadamard matrix, or a matrix obtained by training in an SGD method using Cayley transform). The matrix generation circuitry 830 may may be a Hadamard matrix generation circuitry but is not necessarily limited thereto. The matrix generation circuitry 830 may generate a block-wise orthogonal matrix including a plurality of orthogonal matrices arranged diagonally. The matrix generation circuitry 830 may generate the block-wise orthogonal matrix based on information related to the input activation data or the first data.

The INT computation circuitry 850 may generate the second data by applying the block-wise orthogonal matrix from the matrix generation circuitry 830 to the first data.

In addition, the shifter circuitry 810, the matrix generation circuitry 830, and the INT computation circuitry 850 may perform at least one method described with reference to FIGS. 1 to 6 or an algorithm corresponding to the at least one method.

The electronic apparatuses, quantization apparatuses, computing devices, processors, processing elements, memories, circuitry, matrix generation processing element 130, matrix generation processing element 210, matrix generation processing element 530, matrix generation processing element 630, electronic apparatus 700, processor 710, memory 730, quantization apparatus 800, shifter circuitry 810, matrix generation circuitry 830, INT computation circuitry 850 described herein and disclosed herein described with respect to FIGS. 1-8 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application may be performed by circuitry or controller computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
obtaining first data in an integer (INT) form by performing a first quantization on input activation data;
applying a block-wise orthogonal matrix to the first data to obtain second data; and
performing a second quantization on the second data to obtain third data,
wherein the block-wise orthogonal matrix comprises a plurality of orthogonal matrices arranged diagonally.

2. The method of claim 1, further comprising:
generating the block-wise orthogonal matrix based on information related to one of the input activation data or the first data.

3. The method of claim 2, wherein the generating of the block-wise orthogonal matrix comprises:
deriving a dimension in which an outlier occurs in the input activation data or the first data; and
generating the block-wise orthogonal matrix in response to the derived dimension.

4. The method of claim 3, wherein the deriving of the dimension in which the outlier occurs is performed offline in advance based on data previously constructed in relation to a neural network model.

5. The method of claim 2, wherein the generating of the block-wise orthogonal matrix comprises:
recursively extending or reducing a base orthogonal matrix to generate at least one orthogonal matrix candidate based on the information related to the one of the input activation data or the first data; and
repeatedly arranging the at least one orthogonal matrix candidate diagonally.

6. The method of claim 5, wherein the generating of the block-wise orthogonal matrix comprises:
loading a block-wise orthogonal matrix that is previously generated, from a lookup table, based on the information related to the one of the input activation data or the first data.

7. The method of claim 1, wherein the applying the block-wise orthogonal matrix comprises:
applying the block-wise orthogonal matrix and a scaling factor of the block-wise orthogonal matrix to the first data to obtain the second data.

8. The method of claim 7, wherein the applying the block-wise orthogonal matrix comprises:
in response to the scaling factor of the block-wise orthogonal matrix not being an INT, obtaining transferred a scaling factor, the transferred scaling factor being received by the block-wise orthogonal matrix in response to a portion of the scaling factor of a transpose matrix of the block-wise orthogonal matrix; and
calculating the transferred scaling factor by using a shifter to obtain the second data.

9. The method of claim 1, wherein each of the plurality of orthogonal matrices comprises at least one element of {−1, 0, 1}.

10. The method of claim 1, further comprising:
obtaining a parameter matrix in which a transpose matrix of the block-wise orthogonal matrix and a weight of a neural network model are pre-calculated; and
applying the parameter matrix to the third data to output fourth data.

11. The method of claim 1, wherein respective sizes of the plurality of orthogonal matrices are a same size.

12. The method of claim 1, wherein two or more respective sizes of the plurality of orthogonal matrices are different sizes.

13. A non-transitory computer-readable storage medium storing instructions that, when executed by a processor, cause the processor to perform the method of claim 1.

14. An electronic apparatus, comprising:
processors configured to execute instructions; and
a memory storing the instructions, wherein execution of the instructions configures the processors to: perform a first quantization on input activation data to obtain first data in a form of an integer (INT);
apply a block-wise orthogonal matrix to the first data to obtain second data; and
perform a second quantization on the second data to obtain third data,
wherein the block-wise orthogonal matrix comprises a plurality of orthogonal matrices arranged diagonally.

15. The apparatus of claim 14, wherein the processors are further configured to:
generate the block-wise orthogonal matrix based on information related to one of the input activation data or the first data, and
wherein each of the plurality of orthogonal matrices comprises at least one element of {−1, 0, 1}.

16. The apparatus of claim 14, wherein the applying the block-wise orthogonal matrix comprises:
applying the block-wise orthogonal matrix and a scaling factor of the block-wise orthogonal matrix to the first data to obtain the second data.

17. The apparatus of claim 16, wherein the applying the block-wise orthogonal matrix comprises:
in response to the scaling factor of the block-wise orthogonal matrix not being an INT, obtaining a transferred scaling factor, the transferred scaling factor being received by the block-wise orthogonal matrix in response to a portion of the scaling factor of a transpose matrix of the block-wise orthogonal matrix; and
calculating the transferred scaling factor by using a shifter to obtain the second data.

18. The apparatus of claim 14, wherein the processors are further configured to:
obtain a parameter matrix in which a transpose matrix of the block-wise orthogonal matrix and a weight of a neural network model are pre-calculated; and
apply the parameter matrix to the third data to obtain fourth data.

19. An electronic device, comprising:
shifter circuitry comprising at least one shifter logic; and
integer (INT) operation circuitry comprising at least one INT operation logic,
wherein the shifter circuitry is configured to:
generate first data in a form of an INT by performing a first quantization on input activation data; and
generate second data by applying a block-wise orthogonal matrix to the first data,
wherein the shifter circuitry is configured to:
obtain third data by performing a second quantization on the second data, and
wherein the block-wise orthogonal matrix includes a plurality of orthogonal matrices arranged diagonally.

20. The device of claim 19, further comprising:
matrix generation circuitry including generation logic of at least one block-wise orthogonal matrix,
wherein the generation logic is configured to:
generate the block-wise orthogonal matrix based on information related to the input activation data or the first data, and
wherein the shifter circuitry is configured to:
obtain the second data by performing computation by applying the block-wise orthogonal matrix and a scaling factor of the block-wise orthogonal matrix to the first data.
